(19) United States
(12) Patent Application Publication
(10) Pub. No.: US 2008/0095317 A1
(43) Pub. Date: Apr. 24, 2008

(54) METHOD AND APPARATUS FOR FOCUSING AND DEFLECTING THE ELECTRON BEAM OF AN X-RAY DEVICE

(75) Inventor: Sergio Lemaitre, Whitefish Bay, WI (US)

Correspondence Address: PETER VOGEL;GE HEALTHCARE, 3000 N. GRANDVIEW BLVD., SN-477, WAUKESHA, WI, 53188, US

(73) Assignee: General Electric Company, Schenectady, NY (US)

(21) Appl. No.: 11/549,995

(22) Filed: Oct. 17, 2006

(51) Int. Cl. H01J 35/14

(52) U.S. Cl. 378/138

(57) ABSTRACT

An apparatus for focusing and deflecting the electron beam of an x-ray device is disclosed herein. The apparatus includes a vacuum enclosure, and a cathode assembly disposed within the vacuum enclosure. The cathode assembly is adapted to transmit an electron beam comprising a plurality of electrons. The cathode assembly is generally maintained at a first voltage. The apparatus also includes an anode disposed within the vacuum enclosure. The anode is generally maintained at a second voltage. The apparatus also includes a member disposed within the vacuum enclosure between the cathode assembly and the anode. The member defines an aperture through which the electron beam is passed. The member is generally maintained at the second voltage. A corresponding method for focusing and deflecting the electron beam of an x-ray device is also disclosed.

### FIELD OF THE INVENTION

This disclosure relates generally to a method and apparatus for focusing and deflecting the electron beam of an x-ray device.

### BACKGROUND OF THE INVENTION

X-ray tubes generally include a cathode assembly and an anode assembly disposed within a vacuum vessel. The anode assembly includes an anode having a target track or impact zone that is generally fabricated from a refractory metal with a high atomic number, such as tungsten or tungsten alloy. The cathode assembly emits electrons that form of an electron beam and that impact the target track of the anode assembly at high velocity. As the electrons impact the target track, the kinetic energy of the electrons is converted to high energy electromagnetic radiation, or x-rays. The x-rays are then transmitted through an object such as the body of a patient and are intercepted by a detector that forms an image of the object's internal anatomy.

In a conventional x-ray device, a voltage differential is maintained between the cathode assembly and the anode assembly in order to accelerate the electrons therebetween. This voltage differential generates an electric field having a strength defined as the voltage differential between the anode and the cathode divided by the distance between the anode and the cathode. While it may be beneficial in some applications to increase the distance between the anode and the cathode, it should be appreciated that doing so can diminish electric field strength. Diminishing the electric field strength can reduce the emission of electrons from the cathode assembly which may reduce the life of the filament. Diminishing the electric field strength can also produce a larger influence of space charge on electron beam size, referred to as “blooming”, and can thereby degrade x-ray image quality.

The cathode assembly generally includes a pair of electrodes positioned on opposite sides of the electron beam. A bias voltage is independently applied to each of the electrodes to focus and/or deflect the electron beam. It is generally preferable to perform a desired command to either focus or move the electron beam with a minimal bias voltage at the electrodes. For example, minimizing bias voltage requirements at the electrodes reduces the risk of insulation breakdown in the x-ray tube to improve reliability; reduces insulation requirements to save cost; and reduces heat generation in bias voltage switching components which both improves reliability and saves cost otherwise required for cooling.

### BRIEF DESCRIPTION OF THE INVENTION

The above-mentioned shortcomings, disadvantages and problems are addressed herein which will be understood by reading and understanding the following specification.

In an embodiment, an x-ray apparatus includes a vacuum enclosure, and a cathode assembly disposed within the vacuum enclosure. The cathode assembly is adapted to transmit an electron beam comprising a plurality of electrons. The cathode assembly is generally maintained at a first voltage. The x-ray apparatus also includes an anode disposed within the vacuum enclosure. The anode is generally maintained at a second voltage. The x-ray apparatus also includes a member disposed within the vacuum enclosure between the cathode assembly and the anode. The member defines an aperture through which the electron beam is passed. The member is generally maintained at the second voltage.

In another embodiment, an x-ray apparatus includes a vacuum enclosure, and a cathode assembly disposed within the vacuum enclosure. The cathode assembly is adapted to transmit an electron beam comprising a plurality of electrons. The cathode assembly includes a first and second electrode configured to selectively focus and deflect the electron beam. The cathode assembly is generally maintained at a first voltage. The x-ray apparatus also includes an anode disposed within the vacuum enclosure. The anode is adapted to receive the electron beam from the cathode assembly. The anode is generally maintained at a second voltage. The x-ray apparatus also includes a member disposed within the vacuum enclosure between the cathode assembly and the anode. The member defines an aperture through which the electron beam is passed. The member is generally maintained at the second voltage. An electric field adapted to accelerate the electrons is generated substantially between the cathode assembly and the member, and a field free region through which the electrons drift is defined substantially between the member and the anode.

In yet another embodiment, a method for focusing and deflecting an electron beam of an x-ray device includes providing a vacuum enclosure, and applying a first voltage potential to a cathode assembly disposed within the vacuum enclosure. The cathode assembly is adapted to transmit an electron beam comprising a plurality of electrons. The method also includes applying a second voltage potential to an anode disposed within the vacuum enclosure. The anode is spaced apart from the cathode assembly by an amount selected to allow more efficient focusing and deflection of the electron beam. The method also includes applying the second voltage potential to a member disposed within the vacuum enclosure between the cathode assembly and the anode. The member defines an aperture through which the electron beam passes. The method also includes applying a bias voltage to a first electrode and a second electrode in order to selectively focus and/or deflect the electron beam.

Various other features, objects, and advantages of the invention will be made apparent to those skilled in the art from the accompanying drawings and detailed description thereof.

### BRIEF DESCRIPTION OF THE DRAWINGS

FIG. 1 is a perspective sectional diagram of an x-ray tube in accordance with an embodiment;

FIG. 2 is schematic sectional diagram illustrating the transmission of an electron beam from a cathode assembly to an anode;

FIG. 3 is a schematic sectional diagram illustrating the deflection of the electron beam of FIG. 2; and

FIG. 4 is schematic sectional diagram illustrating an x-ray tube in accordance with an embodiment.

### DETAILED DESCRIPTION OF THE INVENTION

In the following detailed description, reference is made to the accompanying drawings that form a part hereof, and in which is shown by way of illustration specific embodiments that may be practiced. These embodiments are described in sufficient detail to enable those skilled in the art to practice the embodiments, and it is to be understood that other embodiments may be utilized and that logical, mechanical, electrical and other changes may be made without departing from the scope of the embodiments. The following detailed description is, therefore, not to be taken as limiting the scope of the invention.

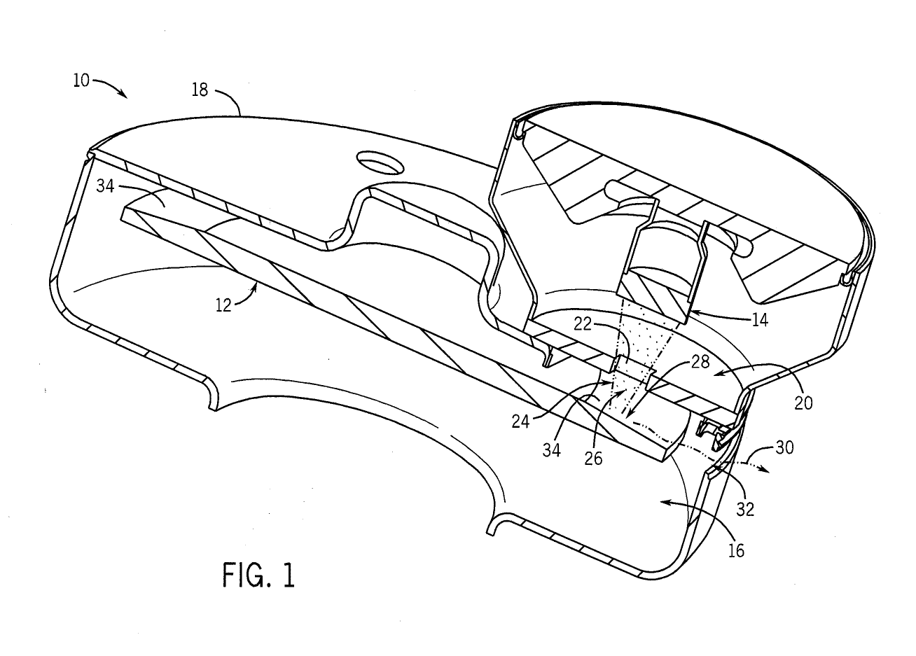

Referring to FIG. 1, a perspective sectional view of an x-ray tube 10 in accordance with an embodiment is shown. The x-ray tube 10 includes an anode 12 and a cathode assembly 14 which are at least partially disposed in a vacuum 16 within a vacuum enclosure or vessel 18. A member 20 defining an aperture 22 is interposed between the anode 12 and the cathode assembly 14. It should be appreciated that the x-ray tube 10 is shown for exemplary purposes, and that the member 20 may be implemented with other x-ray tube configurations.

The cathode assembly 14 generates and emits an electron beam 24 comprising a stream of electrons 26 that are accelerated toward the anode 12. The electrons 26 pass through the aperture 22 of the member 20 and strike a focal spot 28 on the anode 12 such that high frequency electromagnetic waves, or x-rays 30, are produced. A portion of the emitted x-rays 30 are directed out of a window 32 for penetration into an object such as the body of a patient (not shown). The window 32 is hermetically sealed to the vessel 18 in order to maintain the vacuum 16. The window 32 is transmissive to x-rays 30, and preferably only allows the transmission of x-rays having a useful diagnostic amount of energy.

The anode 12 is generally disc-shaped and includes a target track or impact zone 34 that is generally fabricated from a refractory metal with a high atomic number such as tungsten or tungsten alloy. Heat is generated in the anode 12 as the electrons 26 from the cathode assembly 14 impact the target track 34. For example, the temperature of the anode at the focal spot 28 can run as high as about 2,700 degrees C. The anode 12 is preferably rotated so that the electron beam 24 from the cathode assembly 14 does not focus on the same portion of the target track 34 and thereby cause the accumulation of heat in a localized area.

In a conventional x-ray tube, a voltage differential is maintained between the cathode and the anode. In an exemplary conventional monopolar x-ray tube design, the cathode may be held at −200 kilovolts (kV) and the anode is grounded. In an exemplary conventional bipolar x-ray tube design, the cathode may be held at −100 kV and the anode may be held at +100 kV. The voltage differential between the cathode and the anode generates an electric field having a field strength defined as ΔV_{ca}/L_{ca}, where the term ΔV_{ca} is the voltage differential between the cathode and the anode, and the term L_{ca} is the distance between the cathode and the anode. The electric field in a conventional x-ray tube accelerates the electrons from the cathode toward the anode at a rate proportional to the electric field strength. As will be described in detail hereinafter it may be beneficial to increase the distance between the cathode and the anode (L_{ca}), however, it should be appreciated that increasing this distance can also diminish electric field strength.

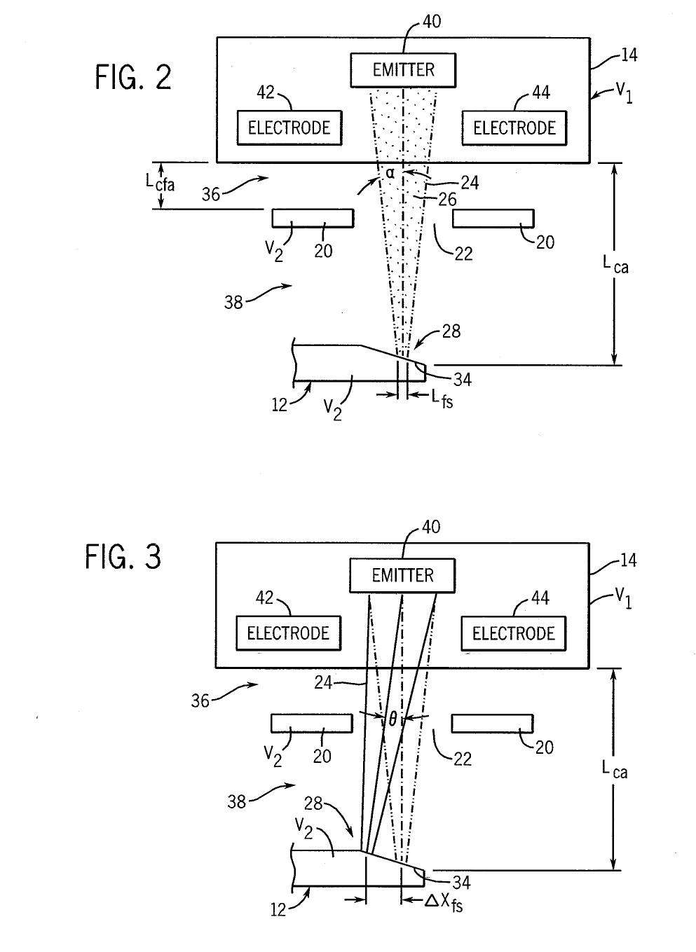

Referring to FIG. 2, a schematic sectional diagram illustrating the transfer of electrons 26 from the cathode assembly 14 to the anode 12 is shown. The electron beam 24 from the cathode assembly 14 passes through the aperture 22 of the member 20 and hits the focal spot 28 on the anode 12. Advantageously, the member 20 can act as a “false anode” for purposes of calculating electric field strength. By interposing the member 20 between the cathode assembly 14 and the anode 12, and by maintaining predetermined voltage potentials at the cathode assembly 14; the anode 12; and the member 20, an electric field 36 is generated between the cathode assembly 14 and the member 20 and a field free region 38 is generated between the member 20 and the anode 12. More precisely, to generate the electric field 36 and the field free region 38, the cathode assembly 14 is held at a first voltage potential V₁, the member 20 is held at a second voltage potential V₂ which may be zero or ground for monopolar tubes, and the anode 12 is also held at the second voltage potential V₂. The electrons 26 are accelerated by the electric field 36 from the cathode assembly 14 to the member 20, and thereafter the electrons 26 drift through the field free region 38 from the member 20 to the anode 12.

The strength of the electric field 36 is a function of the distance between the cathode assembly 14 and the member 20, and is independent of anode 12 location. This distance is labeled in FIG. 2 as L_{cfa} which stands for the distance between the cathode assembly 14 and the false anode or member 20. It should therefore be appreciated that, by incorporating the member 20 configured to act as a false anode, the anode 12 can be moved farther away from the cathode assembly 14 without diminishing the electric field strength.

The cathode assembly 14 preferably includes an emitter 40 positioned between a pair of electrodes 42, 44. The emitter 40 is the portion of the cathode assembly 14 that emits the electrons 26 which form the electron beam 24. A bias voltage is independently applied to the electrodes 42, 44 in order to focus and deflect the electron beam 24. By increasing the magnitude of a common bias voltage applied to both electrodes 42, 44, the electron beam 24 can be made to either converge or diverge more rapidly. More precisely, by increasing the magnitude of a negative bias voltage applied equally to each electrode 42, 44, the electron beam 24 converges with an increasing convergence angle α and, by increasing the magnitude of a positive bias voltage applied to each electrode 42, 44, the electron beam 24 diverges with an increasing divergence angle (not shown). Application of an asymmetrical bias voltage to the two electrodes 42, 44 deflects the electron beam 24, and the amount of angular deflection θ (shown in FIG. 3) is directly proportional to the magnitude of the voltage differential between the two electrodes 42, 44. It is generally preferable to perform a desired command to either focus or move the electron beam 24 with a minimal bias voltage at the electrodes 42, 44. While the present invention has been described as including one pair of electrodes 42, 44 adapted to focus and/or deflect the electron beam 24 along a single axis, it should be appreciated that alternate embodiments may implement additional electrode pairs (not shown) in order to focus and/or deflect an electron beam in other axial directions.

As previously indicated, it can be beneficial to move the anode 12 farther away from the cathode assembly 14. One such benefit relates to a reduction in the electrode 42, 44 bias voltage required to focus and/or deflect the electron beam 24. It can be seen with respect to FIG. 2 that by increasing the distance (L_{ca}) between the cathode assembly 14 and the anode 12, the convergence angle θ required to produce a focal spot of a given size L_{fs}, decreases. Decreasing the convergence angle α correspondingly reduces the requisite amount of bias voltage at the electrodes 42, 44. Similarly, it can be seen with respect to FIG. 3 that by increasing the distance (L_{ca}) between the cathode assembly 14 and the anode 12, the deflection angle θ required to produce a given amount of focal spot movement ΔX_{fs} decreases. Decreasing the deflection angle θ correspondingly reduces the requisite bias voltage differential between the electrodes 42, 44.

The reduction in the electrode 42, 44 bias voltage required to deflect the electron beam 24 is particularly advantageous for applications that implement “double sampling”. “Double sampling” is a technique used in computed tomography (CT) systems to prevent aliasing effects in image reconstruction and thereby improve image quality. Double sampling can be achieved by numerically evaluating two separate images. The two images are generally obtained by moving the focal spot 28 between two different positions on the target track 34 of the anode 12. The process of rapidly moving the focal spot 28 back and forth to obtain two images may be referred to as “wobbling”. Wobbling is produced by rapidly changing the bias voltage applied to each of the electrodes 42, 44 in order to deflect the electron beam 24 by a predetermined amount in a manner similar to that described hereinabove. The process of rapidly changing the bias voltage generates heat in the electronic bias voltage switching components by an amount proportional to the magnitude of bias voltage change. Therefore, by minimizing the requisite bias voltage differential for a given amount of electron beam deflection, less heat is generated during wobbling which improves durability of the bias voltage power supplies and minimizes the expense associated with cooling the power supplies.

Advantageously, the incorporation of the member 20 has the effect of relocating the focal spot 28 from a position within the electric field 36 to a position within the field free region 38. As will be appreciated by those skilled in the art, high voltage instability is often precipitated by localized outgassing of the anode 12 due to focal spot 28 overheating. By moving the focal spot 28 into the field free region 38, a high voltage breakdown event can no longer originate at the focal spot 28 thus enabling more stable tube operation. Improved high voltage stability enables better image quality.

Referring again to FIG. 1, the member 20 is shown in accordance with a preferred embodiment as being generally disc shaped with a rectangular aperture 22. The aperture 22 is preferably conformal meaning that it conforms to the size and shape of the electron beam 24 which is also preferably rectangular. According to an embodiment of the invention, the size of the aperture 22 is just large enough to accommodate the electron beam 24 when the beam 24 is largest and most deflected. By minimizing the size of the aperture 22 in the manner described, the member 20 is better adapted to maintain separation between the electric field 36 (shown in FIG. 2) and the field free region 38 (shown in FIG. 2). While the member 20 and aperture 22 have been shown and described in accordance with a preferred embodiment, it should be appreciated that alternate member and/or aperture configurations may be also envisioned.

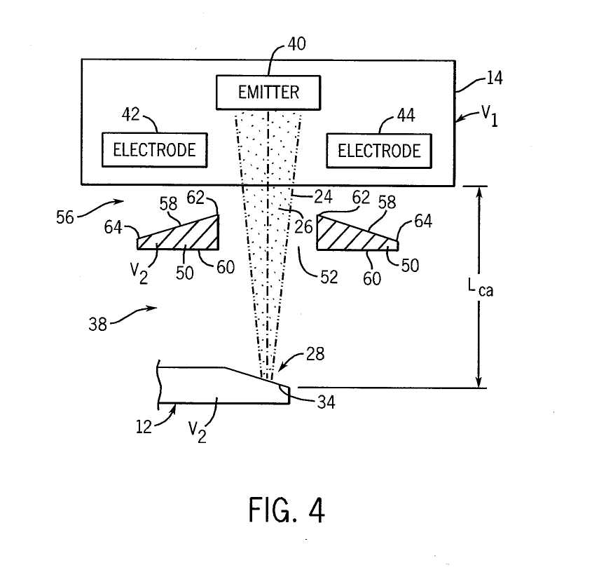

Referring to FIG. 4, a schematic sectional diagram illustrates a member 50 in accordance with an embodiment. Like reference numbers are used to describe like components from the embodiment of FIG. 2. The electron beam 24 from the cathode assembly 14 passes through the aperture 52 of the member 50 and hits the focal spot 28 on the anode 12. Advantageously, the member 50 can act as a “false anode” for purposes of calculating electric field strength. By interposing the member 50 between the cathode assembly 14 and the anode 12, and by maintaining predetermined voltage potentials at the cathode assembly 14; the anode 12; and the member 50, an electric field 56 is generated between the cathode assembly 14 and the member 20 and a field free region 38 is generated between the member 20 and the anode 12. More precisely, to generate the electric field 56 and the field free region 38, the cathode assembly 14 is held at a first voltage potential V₁ , the member 50 is held at a second voltage potential V₂ which may be zero or ground for monopolar tubes, and the anode 12 is also held at the second voltage potential V₂. The electrons 26 are accelerated by the electric field 56 from the cathode assembly 14 to the member 20, and thereafter the electrons 26 drift through the field free region 38 from the member 20 to the anode 12.

The member 50 includes a first surface 58 generally facing the cathode 14, and a second surface 60 generally facing the anode 12. The first surface 58 includes a radially inner end 62 and a radially outer end 64. It has been observed that altering the orientation of the first surface 58 relative to the cathode 14 can make the electron beam 24 either converge or diverge more rapidly. More precisely, by configuring the member 50 as shown in FIG. 4 such that the radially inner end 62 of the first surface 58 is closer to the cathode 14 than radially outer end 64 of the first surface 58, the electric field 56 is distorted in a manner tending to make the electron beam 24 converge more rapidly. Similarly, although not shown in the figures, the electron beam 24 can be made to diverge more rapidly by configuring the member 50 so that the radially outer end 64 of the first surface 58 is closer to the cathode 14 than radially inner end 62 of the first surface 58. Therefore, the first surface 58 of the member 50 may be shaped or oriented in a predetermined manner in order to control the focus of the electron beam 24.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

I claim:

1. An x-ray apparatus comprising:
a vacuum enclosure;
a cathode assembly disposed within the vacuum enclosure, said cathode assembly adapted to transmit an electron beam comprising a plurality of electrons, said cathode assembly generally maintained at a first voltage;
an anode disposed within the vacuum enclosure, said anode generally maintained at a second voltage; and
a member disposed within the vacuum enclosure between the cathode assembly and the anode, said member defining an aperture through which the electron beam is passed, said member generally maintained at said second voltage.

2. The x-ray apparatus of claim 1, further comprising an electric field adapted to accelerate said plurality of electrons generated substantially between the cathode assembly and the member, and a field free region through which said plurality of electrons drift defined substantially between the member and the anode.

3. The x-ray apparatus of claim 2, wherein said aperture generally conforms to the size and shape of the electron beam in order to better maintain separation between the electric field and the field free region.

4. The x-ray apparatus of claim 3, wherein said cathode assembly includes an emitter positioned between a first and second electrode.

5. The x-ray apparatus of claim 4, wherein said first and second electrodes are configured to selectively focus and/or deflect the electron beam by independently applying a bias voltage to each of the first and second electrodes.

6. The x-ray apparatus of claim 5, wherein said member is adapted to allow the cathode assembly and the anode to be separated without diminishing the strength of the electric field in order to reduce the bias voltage requirements for focusing and deflecting the electron beam.

7. The x-ray apparatus of claim 6, wherein said x-ray apparatus is a monopolar x-ray tube and the second voltage is zero.

8. The x-ray apparatus of claim 6, wherein said x-ray apparatus is a bipolar x-ray tube.

9. The x-ray apparatus of claim 1, wherein said member includes a surface generally facing the cathode assembly, and wherein said surface is oriented in a manner adapted to focus the electron beam.

10. An x-ray apparatus comprising:
a vacuum enclosure;
a cathode assembly disposed within the vacuum enclosure, said cathode assembly adapted to transmit an electron beam comprising a plurality of electrons, said cathode assembly including a first and second electrode configured to selectively focus and deflect the electron beam, said cathode assembly generally maintained at a first voltage;
an anode disposed within the vacuum enclosure, said anode adapted to receive the electron beam from the cathode assembly, said anode generally maintained at a second voltage; and
a member disposed within the vacuum enclosure between the cathode assembly and the anode, said member defining an aperture through which the electron beam is passed, said member generally maintained at said second voltage;
wherein an electric field adapted to accelerate said plurality of electrons is generated substantially between the cathode assembly and the member, and a field free region through which said plurality of electrons drift is defined substantially between the member and the anode.

11. The x-ray apparatus of claim 10, wherein said aperture generally conforms to the size and shape of the electron beam in order to better maintain separation between the electric field and the field free region.

12. The x-ray apparatus of claim 11, wherein said member is configured to enable the separation of the anode and the cathode assembly by a predetermined amount selected to allow more efficient focusing and deflection of the electron beam without diminishing the electric field strength.

13. The x-ray apparatus of claim 12, wherein said x-ray apparatus is a monopolar x-ray tube and the second voltage is zero.

14. The x-ray apparatus of claim 12, wherein said x-ray apparatus is a bipolar x-ray tube.

15. The x-ray apparatus of claim 10, wherein said member includes a surface generally facing the cathode assembly, and wherein said surface is oriented in a manner adapted to focus the electron beam.

16. A method for focusing and deflecting an electron beam of an x-ray device comprising:
providing a vacuum enclosure;
applying a first voltage potential to a cathode assembly disposed within the vacuum enclosure, said cathode assembly adapted to transmit an electron beam comprising a plurality of electrons;
applying a second voltage potential to an anode disposed within the vacuum enclosure, said anode being spaced apart from said cathode assembly by an amount selected to allow more efficient focusing and deflection of the electron beam;
applying said second voltage potential to a member disposed within the vacuum enclosure between the cathode assembly and the anode, said member defining an aperture through which the electron beam passes; and
applying a bias voltage to a first electrode and a second electrode in order to selectively focus and/or deflect the electron beam.

17. The method of claim 16, wherein said applying a second voltage potential includes applying zero voltage potential such that the anode and the member are grounded.

18. The method of claim 16, wherein said applying a bias voltage includes applying a common bias voltage to both of said first and second electrodes in order to selectively focus the electron beam.

19. The method of claim 16, wherein said applying a bias voltage includes applying a different bias voltage to each of said first and second electrodes in order to selectively deflect the electron beam.

20. The method of claim 16, further comprising providing a surface of said member that is oriented in a manner adapted to focus said electron beam.
